(19) United States
(12) Patent Application Publication
(10) Pub. No.: US 2026/0092549 A1
(43) Pub. Date: Apr. 2, 2026

(54) MIXING SECTION FOR AN EXHAUST SYSTEM OF AN INTERNAL COMBUSTION ENGINE

(71) Applicant: Purem GmbH, Neunkirchen (DE)

(72) Inventors: Peter Kast, Esslingen (DE); Markus Henzler, Grafenberg (DE); Vincent Eder, Kirchheim (DE); Kirill Karelin, Boeblingen (DE)

(21) Appl. No.: 19/347,498

(22) Filed: Oct. 1, 2025

(30) Foreign Application Priority Data
Oct. 1, 2024 (DE) 10 2024 128 324.6

(51) Int. Cl. F01N 3/28; B01F 25/314

(52) U.S. Cl. CPC F01N 3/2892; B01F 25/3141; F01N 2240/20

(57) ABSTRACT

A mixing section for an exhaust system of a combustion engine includes a mixing section housing, wherethrough exhaust gas can flow. A tubular mixing body is arranged in the housing and extends in the direction of a mixing body longitudinal axis. The mixing body delimits a first flow volume radially with respect to the outside and a second flow volume radially with respect to the inside. The mixing body includes a tubular first body part and, on an outer side of the first body part, includes a tubular second body part. The mixing body is supported radially with respect to the housing via a plurality of first radial support members in a first radial support region. The first body part is supported radially on the housing by the first radial support members, and the second body part is supported radially on the housing by second radial support members.

### CROSS-REFERENCE TO RELATED APPLICATIONS

This application claims priority of German patent application no. 10 2024 128 324.6, filed Oct. 1, 2024, the entire content of which is incorporated herein by reference.

### TECHNICAL FIELD

The present disclosure relates to a mixing section for an exhaust system of an internal combustion engine, including a mixing section housing, through which exhaust gas can flow in a main exhaust-gas flow direction, and a tubular mixing body, which is arranged in the mixing section housing and extends in the direction of a mixing body longitudinal axis. The mixing body delimits a first flow volume, through which exhaust gas can flow, radially with respect to the outside, and delimits a second flow volume, through which exhaust gas can flow, radially with respect to the inside. The mixing body includes a tubular first mixing body part, which extends in the direction of the mixing body longitudinal axis, and, on an outer side of the first mixing body part, which outer side faces the second flow volume, includes at least one tubular second mixing body part, which extends in the direction of the mixing body longitudinal axis, wherein the second mixing body part is supported radially on the first mixing body part at a plurality of mixing-body-part support regions.

### BACKGROUND

Such a mixing section for an exhaust system is known from German Patent Application 10 2024 119 108.2, which is a later publication. Since, in such a mixing section, the mixing body, around which exhaust gas flows on its outer side and its inner side, may be subject to more intense heating than the mixing section housing, which is generally surrounded by ambient air on its outer side, differences in the thermally induced expansion of the mixing section housing, on the one hand, and of the mixing body, on the other hand, may arise during operation.

### SUMMARY

It is an object of the present disclosure to provide a mixing section for an exhaust system of an internal combustion engine which ensures efficient mixing of exhaust gas and reagents injected into the latter while simultaneously compensating for differences in the thermally induced expansion of mixing section components.

According to the disclosure, this problem is solved by a mixing section for an exhaust system of an internal combustion engine, including:
a mixing section housing, through which exhaust gas can flow in a main exhaust-gas flow direction,
a tubular mixing body, which is arranged in the mixing section housing and extends in the direction of a mixing body longitudinal axis, wherein the mixing body delimits a first flow volume, through which exhaust gas can flow, radially with respect to the outside, and delimits a second flow volume, through which exhaust gas can flow, radially with respect to the inside, wherein the mixing body includes a tubular first mixing body part, which extends in the direction of the mixing body longitudinal axis, and, on an outer side of the first mixing body part, which outer side faces the second flow volume, includes at least one tubular second mixing body part, which extends in the direction of the mixing body longitudinal axis, wherein the second mixing body part is supported radially on the first mixing body part at a plurality of mixing-body-part support regions.

The mixing section according to the disclosure is distinguished by the fact that the mixing body is supported radially with respect to the mixing section housing via a plurality of first radial support members in a first radial support region, and is supported radially with respect to the mixing section housing via a plurality of second radial support members in a second radial support region, which is arranged at a distance from the first radial support region in the direction of the mixing body longitudinal axis, and that the first mixing body part is supported radially on the mixing section housing by the first radial support members, and the second mixing body part is supported radially on the mixing section housing by the second radial support members.

In the mixing section according to the disclosure, the supporting functions to be implemented in the two radial support regions arranged at an axial distance from one another are distributed between the first mixing body part of the mixing body, which is arranged radially further in, and the second mixing body part, which surrounds the first mixing body part on the outside thereof. This enables the supporting functionalities that are to be implemented in the various radial support regions, some of which are intended to allow relative mobility but some are intended to ensure defined fixed positioning, to be distributed in an optimum manner over the mixing body as a whole. At the same time, the second mixing body part, around which exhaust gas flows on its inner side and its outer side, provides the function of a heat exchanger, which absorbs heat from the exhaust gas and, by virtue of the contact with the first mixing body part that exists in the region of the mixing-body-part support regions, transfers it to the first mixing body part. Since there is a flow of exhaust gas around the two mixing body parts, on the outer side and the inner side thereof in each case, these have substantially the same temperature during operation, and therefore, taking into consideration also the fact that the two mixing body parts can be constructed from the same material, in particular a metallic material, it is essentially impossible for differential thermally induced changes in dimensions of the mixing body parts to occur.

In order, on the one hand, to ensure defined positioning of the mixing body with respect to the mixing section housing but, on the other hand, to avoid stresses induced by differences in thermal expansion, it is proposed that the first mixing body part is held fast on the mixing section housing by the first radial support members against movement in the direction of the mixing body longitudinal axis and/or movement in the circumferential direction around the mixing body longitudinal axis, and that the second mixing body part is supported radially on the mixing section housing by the second radial support members in such a way as to be movable in the direction of the mixing body longitudinal axis and/or in the circumferential direction around the mixing body longitudinal axis.

A defined supporting function can furthermore be assisted by the fact that a plurality of first radial support members is provided at a circumferential distance from one another in the circumferential direction around the mixing body longitudinal axis, and/or that a plurality of second radial support members is provided at a circumferential distance from one another in the circumferential direction around the mixing body longitudinal axis.

Structural integration of the supporting function to be implemented in the second radial support region into the components of the mixing section can be achieved by virtue of the fact that at least some of the second radial support members, preferably all the second radial support members, include supporting protuberances on the second mixing body part which point in a direction away from the first mixing body part, and/or include supporting protuberances on the mixing section housing which point in a direction toward the second mixing body part. The provision of additional components that implement the supporting function can thereby be avoided.

As a result of the provision of radial support members as protuberances, for example, on the second mixing body part or on the mixing section housing, that is, as convexly curved protuberances pointing toward the respective other component, there is in the region of such protuberances a radial elasticity which enables even the compensation of differences in the thermally induced radial expansion of the mixing section housing, on the one hand, and of the mixing body, on the other hand.

To ensure the mobility of the mixing body relative to the mixing section housing, it is possible here to envisage that the supporting protuberances on the second mixing body part are supported on an inner surface of the mixing section housing in such a way as to be movable in the direction of the mixing body longitudinal axis and/or in the circumferential direction around the mixing body longitudinal axis, and/or that the supporting protuberances on the mixing section housing are supported on an outer surface of the second mixing body part in such a way as to be movable in the direction of the mixing body longitudinal axis and/or in the circumferential direction around the mixing body longitudinal axis. If such protuberances, each pointing toward the other component, are provided on both components, that is, in this case the mixing section housing and the second mixing body part, these protuberances can be associated with one another in pairs, such that protuberances on the second mixing body part are supported radially on protuberances on the mixing section housing that are respectively associated therewith.

For axially and/or circumferentially fixed retention of the mixing body on the first radial support region, at least some of the first radial support members, preferably all the first radial support members, can include support elements which are fixed on the mixing section housing and the first mixing body part, preferably by material joining, for example, welding or brazing.

In order to obtain a configuration with as few components as possible, it is possible as an alternative or in addition for at least some of the first radial support members, preferably all the first radial support members, to include supporting protuberances on the first mixing body part which point in a direction toward the mixing section housing and are fixed on the mixing section housing, preferably by material joining, for example, welding or brazing, and/or to include supporting protuberances on the mixing section housing which point in a direction toward the first mixing body part and are fixed on the first mixing body part, preferably by material joining, for example, welding or brazing.

In order to ensure defined positioning of the mixing body in the mixing section, particularly in an upstream region of the mixing body, in which the injection of a reagent generally also takes place, it is proposed that the first radial support region is provided in an upstream end region of the mixing body, preferably upstream of the second mixing body part, and/or that the second radial support region is provided in a downstream end region of the mixing body.

For defined positioning of the radially inner first mixing body part with respect to the mixing section housing, at least some of the second radial support members, preferably all the second radial support members, overlap axially with some of the mixing-body-part support regions.

To provide the mixing-body-part support regions, the second mixing body part can have a plurality of first protuberances, which are arranged adjacent to one another in the direction of the mixing body longitudinal axis and in the circumferential direction around the mixing body longitudinal axis and which point toward the first mixing body part, wherein at least one first protuberance, preferably each first protuberance, forms a mixing-body-part support region.

To obtain a substantially regular protuberance pattern and thus substantially uniformly distributed heat transfer between the two mixing bodies, it is proposed that the first protuberances are arranged in a plurality of rows of first protuberances which are arranged successively in the circumferential direction around the mixing body longitudinal axis and preferably extend substantially in the direction of the mixing body longitudinal axis, and/or that the first protuberances are arranged in a plurality of rings of first protuberances which are arranged successively in the direction of the mixing body longitudinal axis and preferably extend substantially in the circumferential direction around the mixing body longitudinal axis.

For particularly efficient heat transfer between the second mixing body part and the first mixing body part, it is proposed that at least some of the first protuberances, preferably each first protuberance, are/is configured as a closed protuberance, and/or at least some of the first protuberances, preferably each first protuberance, are/is formed with a protuberance circumferential wall and a protuberance base, which rests against the first mixing body part and is preferably substantially planar or curved in a manner matched substantially to a curvature of the first mixing body part, and/or that at least some of the first protuberances, preferably each first protuberance, are/is of circular configuration.

A further intensified thermal interaction with the exhaust gas can be achieved in that the second mixing body part has a plurality of second protuberances, which are arranged adjacent to one another in the direction of the mixing body longitudinal axis and in the circumferential direction around the mixing body longitudinal axis and which point away from the first mixing body part.

If in this case it is furthermore provided that at least one opening is provided in the second mixing body part adjoining at least some of the second protuberances, preferably each second protuberance, preferably wherein, in each pair consisting of mutually associated second protuberance and opening, the second protuberance and the opening overlap one another in some region or regions, there is the possibility that exhaust gas that has flowed into the gap between the two mixing body parts will flow out of this gap again and will be replaced by even hotter exhaust gas flowing into this gap and will transfer heat to the mixing body parts.

The outflow and inflow of exhaust gas from and into the gap formed between the two mixing body parts can be further assisted in that, in the case of some of the pairs consisting of mutually associated second protuberance and opening, the opening is arranged on a first side, preferably a first axial side, of the associated second protuberance and, in the case of others of the pairs consisting of mutually associated second protuberance and opening, the opening is arranged on a second side, substantially opposite the first side, preferably a second axial side, of the associated second protuberance.

In connection with the second protuberances, it is also possible to provide a regular protuberance pattern that assists uniformly distributed heat transfer by arranging the second protuberances in a plurality of rows of second protuberances which are arranged successively in the circumferential direction around the mixing body longitudinal axis and preferably extend substantially in the direction of the mixing body longitudinal axis, and/or by arranging the second protuberances in a plurality of rings of second protuberances which are arranged successively in the direction of the mixing body longitudinal axis and preferably extend substantially in the circumferential direction around the mixing body longitudinal axis.

To introduce a reagent, a reagent discharge arrangement for discharging reagent substantially only into the first flow volume can be arranged upstream of the mixing body in the main exhaust-gas flow direction. Thus, since substantially no reagent gets into the gap formed between the two mixing body parts, there is no risk that reagent deposits will form in this gap.

A stable connection between the two mixing body parts which promotes heat transfer can be achieved, for example, in that the second mixing body part is fixed on the first mixing body part in the region of at least some of the mixing-body-part support regions, preferably of all the mixing-body-part support regions, preferably by material joining, for example, welding or brazing. Since the two mixing body parts have substantially the same temperature during operation and are preferably constructed with the same material or with materials that have substantially the same thermal expansion coefficient, there is no risk here that stresses will occur on account of the fixing of the two mixing body parts to one another.

The present disclosure furthermore relates to an exhaust system for an internal combustion engine, including a mixing section constructed in accordance with the disclosure and, downstream of the mixing section, an exhaust gas treatment unit, preferably an SCR catalytic converter.

### BRIEF DESCRIPTION OF DRAWINGS

The invention will now be described with reference to the drawings wherein:

FIG. 1 shows a diagrammatic illustration of an exhaust system for an internal combustion engine having a mixing section;

FIGS. 2A and 2B show a cross-sectional view of the exhaust system in FIG. 1 sectioned along a line IIa)-IIa) in FIG. 1, and a cross-sectional view of the exhaust system in FIG. 1 sectioned along a line IIb)-IIb) in FIG. 1;

FIG. 3 shows a perspective view of a mixing body constructed with two tubular mixing body parts;

FIG. 4 shows a longitudinally sectioned detail view of the mixing body;

FIG. 5 shows a cross-sectional view of the mixing body in a section plane corresponding to section plane IIb)-IIb);

FIGS. 6A to 6D show various types of configuration of radial support members.

### DETAILED DESCRIPTION

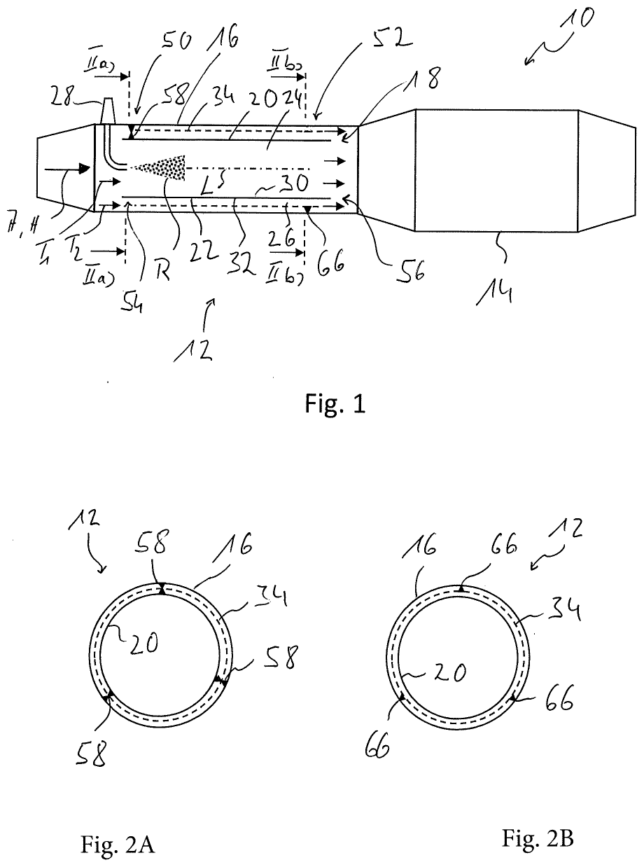

FIG. 1 illustrates diagrammatically a portion of an exhaust system, denoted overall by 10, for an internal combustion engine. The exhaust system 10 includes a mixing section, denoted overall by 12, and an exhaust gas treatment unit 14 downstream of the mixing section 12. In the example illustrated, the exhaust gas treatment unit 14 includes an SCR catalytic converter.

The mixing section 12 includes a mixing section housing 16, in which a substantially tubular mixing body 18 that is elongate in the direction of a mixing body longitudinal axis L is arranged. Exhaust gas discharged by an internal combustion engine, in particular a diesel internal combustion engine, flows in a main exhaust-gas flow direction H corresponding substantially to the orientation of the mixing body longitudinal axis L into the mixing section housing 16 and onto the mixing body 18.

The mixing body 18 includes a tubular first mixing body part 20 having a closed circumferential wall 22 that is, for example, substantially cylindrical and is, for example, configured with a circular cross section. The first mixing body 20 or the circumferential wall 22 thereof divides the internal volume of the mixing section housing 16 in the axial region of extent of the mixing body 18 into a first flow volume 24, which is formed in the interior of the first mixing body part 20 or the circumferential wall 22 thereof and is surrounded by the circumferential wall 22 or delimited radially toward the outside by the wall, and a second flow volume 26, which is formed between the mixing section housing 16 and the first mixing body part 20 or is delimited thereby radially toward the inside.

The exhaust system 10 or the mixing section 12 furthermore includes a reagent discharge arrangement 28, generally also referred to as an injector, which injects a reagent R, for example, a urea/water solution, in the form of a spray mist, that is, in the form of fine droplets, into the exhaust gas A flowing in the mixing section housing 16.

The reagent discharge arrangement 28 is configured in such a way that it discharges the reagent R into the first flow volume 24 and consequently into a partial stream T1 of the exhaust gas A flowing in the first flow volume 24. Thus, substantially no reagent R is injected into the second flow volume 26 and into a second partial stream T2 of the exhaust gas A flowing in the second flow volume 26. Thus, only the exhaust gas A, that is, the second partial stream T2, flows through the second flow volume 26 and, as explained in detail below, the volume serves primarily to transfer heat transported in the exhaust gas A to the mixing body 18 or the first mixing body part 20. Owing to the intensified heating of the first mixing body part 20, the evaporation of reagent R that comes into contact with an inner side 30 of the circumferential wall 22, and thus improved mixing of reagent R and exhaust gas A, are achieved without the need, for this purpose, for system regions, for example, a mixer or the like, that lead to increased flow resistance.

A tubular second mixing body part 34 is arranged on an outer side 32 of the circumferential wall 22 of the first mixing body part 20, the side facing the second flow volume 26. This second mixing body part surrounds the first mixing body part 20, preferably substantially completely over the entire axial region of extent thereof and in the circumferential direction and essentially performs the function of a heat exchanger, via which heat transported in the second partial stream T2 of the exhaust gas A can be transferred more intensively into the mixing body 18.

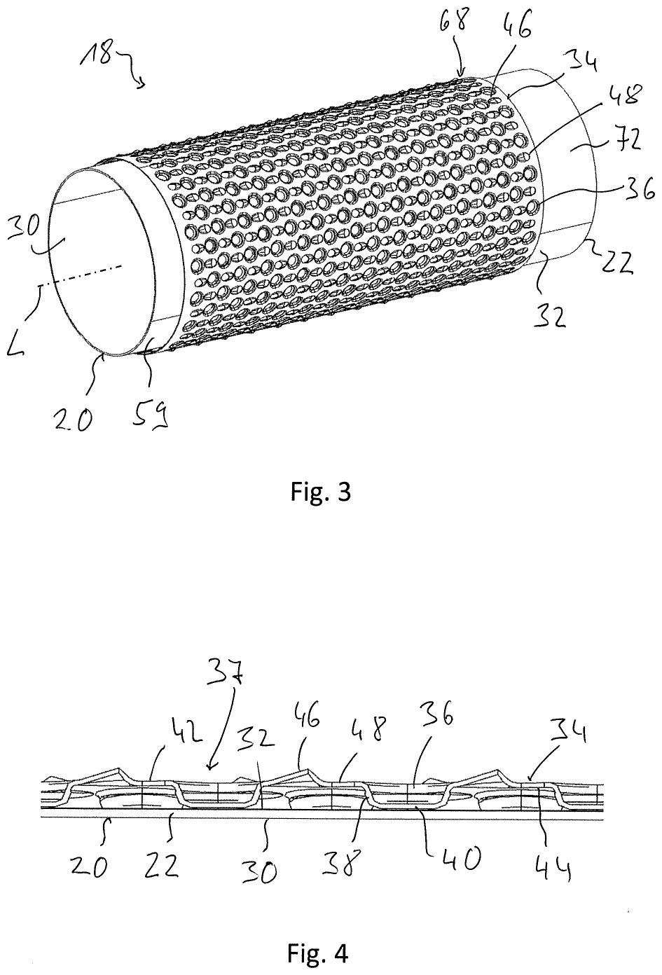

Before the retention of the mixing body 18 in the mixing section housing 16 is described in detail below, primarily with reference to FIGS. 1, 2, 5 and 6, the retention being implemented in accordance with the principles of the present disclosure, the structure of the mixing body 18 with the tubular first mixing body part 20 and the circumferential wall 22 thereof, which is closed in the circumferential direction, and the tubular second mixing body part 34, which surrounds the first mixing body part 20 or the circumferential wall 22 thereof, the structure being fundamentally known from German Patent Application DE 10 2024 119 108.2, which is a later publication, will first of all be described with reference to FIGS. 3 and 4.

The second mixing body part 34, which, like the first mixing body part 20, is configured as a formed sheet metal part, for example, has a multiplicity of, for example, substantially cup-like, first protuberances 36, which are arranged in a manner distributed along the axial length of the second mixing body part 34 and in the circumferential direction around the mixing body longitudinal axis L. The cup-like first protuberances 36 are formed on the second mixing body part 34 in such a way that they extend from a base level of the second mixing body part 34, the base level being at a substantially constant distance from the outer side 32 of the first mixing body part 20, toward the outer side 32 of the first mixing body part 20 and rest against it. Each first protuberance 36 resting against the outer side 32 of the first mixing body part 20 forms a mixing-body-part support region 37, via which the second mixing body part 34 is supported radially on the first mixing body part 20.

The protuberances 36 are formed with a protuberance circumferential wall 38 and a protuberance base 40, which rests against the outer side 32 of the first mixing body part 20, and have a circular configuration in plan view. The protuberance base 40 is substantially planar or matched to the curvature of the outer side 32 of the first mixing body part 20, and therefore there is surface contact between the second mixing body part 34 and the first mixing body part 20 in the region of the protuberance base 40. A material bond is produced between the two mixing body parts 20, 34, for example, by welding or brazing, preferably in the region of all the first protuberances 36, in order to form a good heat transfer contact.

It can be seen in FIG. 3 that a multiplicity of rows of first protuberances 36 extending substantially in the direction of the mixing body longitudinal axis L is formed on the second mixing body part 34. In the case of rows of first protuberances 36 which are directly adjacent to one another in the circumferential direction, the first protuberances 36 are offset with respect to one another in the direction of the mixing body longitudinal axis L, and therefore a first protuberance 36 of one of the rows is positioned between two first protuberances 36 of the respective other row in the direction of the mixing body longitudinal axis L. For a uniform heat transfer contact, the first protuberances 36 that follow one another in the direction of the mixing body longitudinal axis L in the rows of first protuberances 36 are preferably arranged at a substantially uniform distance from one another.

Likewise, rings of first protuberances 36 that run around the mixing body longitudinal axis L in the circumferential direction are formed on the second mixing body part 34. In these rings of first protuberances 36 too, the first protuberances 36 are at a substantially uniform distance from one another, and in the case of rings of first protuberances 36 that are directly adjacent to one another in the direction of the mixing body longitudinal axis L, the first protuberances 36 are offset with respect to one another in the circumferential direction, such that a first protuberance of one of the two rings is positioned between two first protuberances 36 of the respective other ring in the circumferential direction.

Via such a substantially uniform pattern of first protuberances 36 over the entire axial extent of the second mixing body part 34 and over the entire circumference thereof, a substantially uniform heat transfer contact is produced between the two mixing body parts 34, 20. Exhaust gas A of the second partial stream T2 flowing along the second mixing body part 34 in the second flow volume 26 can thus flow around the second mixing body part 34 on its outer side 42 facing away from the first mixing body part 20 and on its inner side 44 facing the first mixing body part 20 and, in the process, can transfer heat to the part. The heat absorbed in the second mixing body part 34 is transferred to the first mixing body part 20 via the contact between the two mixing body parts 34, 20 in the region of the first protuberances 36. It is particularly advantageous here that, owing to the provision of the multiplicity of first protuberances 36 in the region of the inner side 44 and the outer side 42 of the second mixing body part 34, turbulence occurs, which improves the thermal interaction of the exhaust gas A in the second partial stream T2 with the second mixing body part 34.

For an even better thermal interaction and intensified heat transfer to the first mixing body part 20, the second mixing body part 34 has a multiplicity of second protuberances 46. Each second protuberance 46 is assigned an opening 48, thus forming respective pairs of second protuberances 46 and openings 48. The second protuberances 46 are oriented radially outward, that is, in a direction away from the first mixing body part 20, with respect to the mixing body longitudinal axis Land are positioned in such a way with respect to the respectively associated opening 48 that, in each pair consisting of a second protuberance 46 and an opening 48, these overlap each other, that is, the opening 48 extends into the region of the protuberance 46. This gives the structure that can be seen in FIG. 4, in which each such second protuberance 46 is formed in the manner of a segment of a spherical cap or a similarly shaped cap and is open in the direction of the respectively associated opening 48.

It can furthermore be seen in FIGS. 3 and 4 that, in each pair consisting of a second protuberance 46 and an opening 48, these are arranged axially in succession in the direction of the mixing body longitudinal axis L. The second protuberances 46 or openings 48 or pairs of second protuberances 46 and openings 48 are also arranged in rows that run substantially in the direction of the mixing body longitudinal axis L, wherein, here too, the arrangement is such that the second protuberances 46 or openings 48 or pairs of second protuberances 46 and openings 48 are offset with respect to one another in the direction of the mixing body longitudinal axis L in the circumferential direction of directly adjacent rows of second protuberances 46. Likewise, the second protuberances 46 or the associated openings 48 or pairs of second protuberances 46 and openings 48 form respective rings running in the circumferential direction, wherein, in the case of rings that are directly adjacent to one another in the direction of the mixing body longitudinal axis L, the second protuberances 46, which are positioned at a uniform distance from one another both in the circumferential direction and in the direction of the mixing body longitudinal axis L, are also offset with respect to one another. In particular, a structure is provided here in which the second protuberances 46 or openings 48 are each integrated between two first protuberances 36, both in the axial direction and in the circumferential direction, thus giving an alternating sequence of first protuberances 36 and second protuberances 46, each with an associated opening 48, both in the axial direction and in the circumferential direction, and consequently the rows and rings of first protuberances 36 correspond to the rows and rings of second protuberances 46.

It can furthermore be seen in FIG. 3 that, given in each case two rows of second protuberances 46 that are directly adjacent to one another in the circumferential direction, the openings 48 are positioned on different sides of the second protuberances 46. In the case of one of two rows of second protuberances 46 that are directly adjacent to one another in the circumferential direction, the associated openings 48 are positioned on a first side, in particular a first axial side, of the second protuberances 46, whereas, in the case of the other row of two rows of second protuberances 46 that are directly adjacent to one another in the circumferential direction, the associated openings 48 are positioned on the other side, that is, in particular, the other axial side, of the second protuberances 46. Thus, in the case of directly mutually adjacent rings of second protuberances, an alternating pattern of the axial opening direction of the second protuberances 46 is obtained both in the circumferential direction and in the axial direction, thereby assisting the inflow of exhaust gas A into a gap 50 formed between the two mixing body parts 20, 34 and the outflow of exhaust gas A from this gap 50. The second protuberances 46 thus contribute not only to intensifying the turbulence in that region of the second mixing body part 34 which is close to the surface but also assist exhaust gas exchange in the gap 50, thereby improving the heat transfer between the two mixing body parts 34, 20 and also the thermal contact between the first mixing body part 20 and the second partial stream T2 flowing in the second flow volume 26.

Many different variations of the construction of the mixing body 18 illustrated in the figures can be implemented. Thus, for example, the rows of first and second protuberances 36, 46 can have an orientation that deviates from the parallel orientation with respect to the mixing body longitudinal axis L, that is, can have a circumferential extension component, thus giving a pattern resembling a screw thread in the circumferentially mutually adjacent rows of first and second protuberances 36, 46. In another configuration, the second mixing body part 34 could be arranged on the inner side 30 of the first mixing body part 20, while the reagent discharge arrangement 28 can then be configured to introduce the reagent R into the second flow volume 26, such that substantially only exhaust gas A flows through the first flow volume 24. It is also possible to arrange a plurality of such second mixing body parts 34 one behind the other in the direction of the mixing body longitudinal axis L, for example, at an axial distance from one another, wherein, with second mixing body parts 34 one behind the other in the axial direction, the rows of first and second protuberances 36, 46 can then, for example, be offset in the circumferential direction with respect to one another.

It is also possible to vary the number of first protuberances 36 and second protuberances 46. Thus, it would be possible, for example, for two second protuberances 46, each with an associated opening 48, to be positioned between in each case two first protuberances 36 in the axial direction and/or in the circumferential direction, or it would be possible for two or more first protuberances 36 to be provided between two second protuberances 46 with associated opening 48.

In another alternative configuration, it is possible, in the case of at least some of the second protuberances 46, in association with a respective second protuberance 46, to provide two openings 48 on mutually opposite sides of the second protuberance 46. Each of these openings 48 can then extend into the associated second protuberance 46 or can overlap therewith axially, for example, with the result that the second protuberance 46 forms a bridge between the two openings 48 associated therewith, the bridge being directed away from the first mixing body part 20.

Finally, provision can be made, at least in a partial region of the mixing body 18, for at least some of the first protuberances 36 and/or some of the second protuberances 46 with the respectively associated openings 48 not to be arranged in the symmetrical or ordered structure illustrated in the figures, but instead for a static or random distribution of these protuberances 36, 46 with nonuniform mutual spacings in the circumferential direction and in the axial direction and without a defined alignment with respect to one another in the circumferential direction and in the axial direction to be provided.

The retention of the mixing body 18 in the mixing section housing 16 in the manner implemented according to the principles of the present disclosure is described below.

In the mixing section housing, the mixing body 18 is held on the mixing section housing 16 in two radial support regions 50, 52 spaced apart in the direction of the mixing body longitudinal axis L. Here, the first radial support region 50 is provided on an upstream end region 54 of the mixing body 18 and, as explained below, serves to support the mixing body 18 fixedly on the mixing section housing 16, including in the axial direction. The second radial support region 52 is provided on a downstream end region 56 of the mixing body 18 and, as explained below, serves to support the mixing body 18 radially on the mixing section housing 16 but fundamentally to allow relative movements between the mixing body 18 and the mixing section housing 16.

The first radial support region 50 includes a plurality of first radial support members 58 which, while being situated in the same axial region with respect to the mixing body longitudinal axis L, can be arranged in a manner distributed at a uniform distance from one another in the circumferential direction. In the configuration examples illustrated in FIG. 2A, three such first radial support members 58 are provided, which can be at an angular distance of about 120° from one another, for example.

Via each of the first radial support members 58, the first mixing body part 20 is supported radially with respect to the mixing section housing 16 in the first radial support region 50, and is held fast on the mixing section housing 16 in the direction of the mixing body longitudinal axis L and also in the circumferential direction around the mixing body longitudinal axis L. For this purpose, the first radial support members 58 can be provided or fixed between a portion 59 of the first mixing body part 20, which is visible in FIG. 3 and projects axially beyond the second mixing body part 34 at the upstream end region 54 of the mixing body 18. The first radial support region 50 or the first radial support members 58 thereof is/are upstream of the second mixing body part 34 in respect of the main exhaust-gas flow direction H.

For example, as illustrated in FIG. 6A, the first radial support members can be provided as separately formed support elements 60, for example, of bolt-type configuration, which can be fixed in the radially inner region by material joining, that is, for example, welding or brazing, to the first mixing body part 20 in the region of portion 59 and can be fixed in the radially outer region on the mixing section housing 16 by material joining, for example, welding or brazing.

Via the support elements, positioning of the mixing body 18 in the mixing section housing 16 in the upstream end region of the mixing body 18 in a manner defined in the direction of the mixing body longitudinal axis L, in the circumferential direction around the mixing body longitudinal axis Land in the radial direction is thus ensured. Such defined positioning of the mixing body 18 in its upstream end region 54 is particularly advantageous since it is also in this region that the reagent R is injected into the mixing section 12, and defined positioning of the mixing body 18 can ensure that substantially no reagent R gets into the second flow volume 26.

Alternative configurations of such first radial support members 58 are illustrated in FIGS. 6B, 6C and 6D.

FIG. 6B shows a configuration in which the radial support members 58 are formed by supporting protuberances 62 on portion 59 of the first mixing body part 20 which point radially outward, that is, in the direction of the mixing section housing 16. The supporting protuberances 62, which are configured as convexly curved protuberances, are supported in their vertex region on the inner side of the mixing section housing 16 and, in this region, are fixed on the mixing section housing 16 by material joining, for example, welding or brazing.

These supporting protuberances 62 can have a configuration substantially in the form of a spherical cap, but, as an alternative, may also have a pot-like or dish-like configuration, as described above with reference to the first protuberances 36 of the second mixing body part 34.

In the configuration illustrated in FIG. 6C, the first radial support members 58 are provided by supporting protuberances 64 which are provided on the mixing section housing 16 and point radially inward toward the first mixing body part 20 or portion 59 thereof. These too can have the shape described above with reference to the supporting protuberances 62 and can be fixed in the vertex region or base region thereof on the first mixing body part 20 by material joining, preferably welding or brazing.

FIG. 6D shows a configuration in which such supporting protuberances 62, 64 are provided both on the first mixing body part 20 and on the mixing section housing 16. These are preferably arranged in such a way that respective pairs of supporting protuberances 62, 64 are formed, such that supporting protuberances 62 on the first mixing body part 20 rest in the vertex region or base region thereof against respectively associated supporting protuberances 64 on the mixing section housing 16 and are connected to them by material joining, for example, welding or brazing.

The configuration of the first radial support members 58 as integral parts of the first mixing body part 20 or mixing section housing avoids the provision of additional components and, by virtue of the fact that the mixing section housing 16 or the first mixing body part 20 has a radial elasticity in the region of such supporting protuberances 62, 64, offers the possibility of compensating for differences in the thermally induced radial expansion of the mixing section housing 16, on the one hand, and of the first mixing body part 20, on the other hand.

In the second radial support region 52, the mixing body 18 is supported radially with respect to the mixing section housing 16 in the region of its downstream end region 56 by a plurality of second radial support members 66. The second radial support members 66 act between the second mixing body part 34 and the mixing section housing 16 and, as illustrated in FIG. 2B, can be arranged at a uniform distance with respect to one another in the circumferential direction around the mixing body longitudinal axis L, preferably being situated in the same axial region. In the configuration illustrated in FIG. 2B with three such second radial support members 66, these can be at an angular distance of 120° from one another.

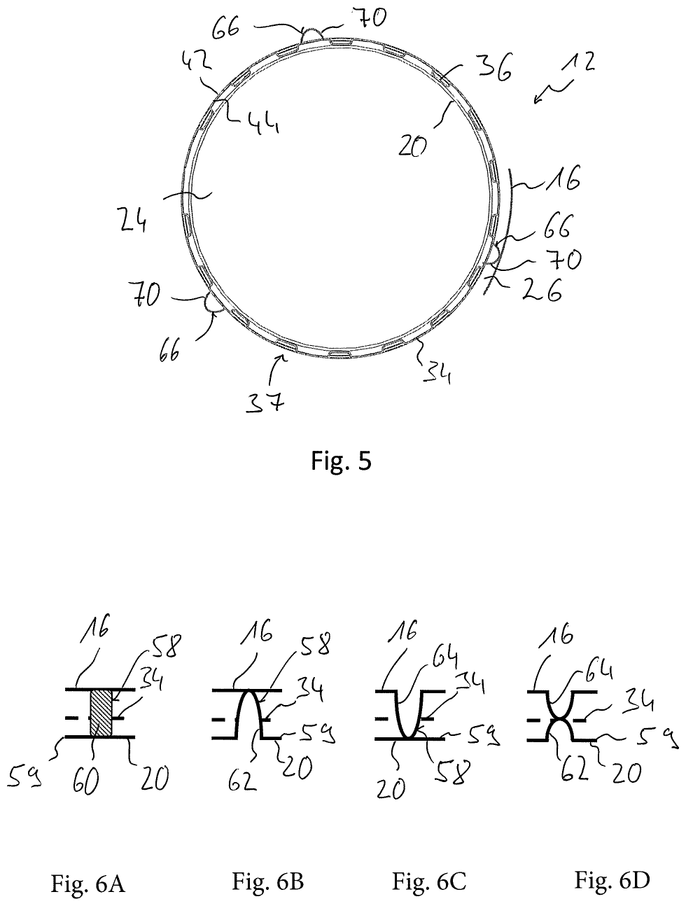

The second radial support members 66 are provided on a downstream end region 68 of the second mixing body part 34 and, for example, are provided by supporting protuberances 70 on the second mixing body part 34 which can be seen in FIG. 5 and are oriented radially outward, that is, in the direction of the mixing section housing 16. For example, a supporting protuberance 70 of this kind can be arranged between two first protuberances 36 on the second mixing body part 34 that follow one another in the circumferential direction. To make this possible, a second protuberance 46 with an associated opening 48 can, for example, be provided between the two first protuberances 36 concerned in such a region of the second mixing body part 34. Instead of such second protuberances 46 or opening 48, an outward-pointing supporting protuberance 70 can be formed at such a location and, as illustrated in FIG. 5, can have the shape of a spherical cap or the like, for example, or can have a similar shape to that of the first protuberances 36.

The second radial support region 52 or the second radial support members 66 thereof is/are thus situated substantially in the same axial region as some of the first protuberances 36 which are provided on the second mixing body part 34 and each form a mixing-body-part support region 37, and therefore at least some, preferably all, of the second radial support regions 66 overlap axially in the axial direction or in the direction of the main exhaust-gas flow direction H with some of the first protuberances 36 or of the mixing-body-part support regions 37. For example, the second radial support regions 66 can be arranged in the same axial region as or in axial overlap with the first protuberances 36 in the ring of first protuberances which is positioned furthest downstream with respect to the main exhaust-gas flow direction H.

Via these supporting protuberances 70, the mixing body 18 is supported radially in its downstream end region 56 on the mixing section housing 16 but is fundamentally not fixed with respect to the mixing section housing 16. If differences in the thermal expansion of the mixing body 18, on the one hand, and of the mixing section housing 16, on the other hand occur, the mixing body 18 can move, in particular in an axial direction, with its supporting protuberances 70 along the inner surface of the mixing section housing 16, thus avoiding stresses that arise from differences in thermal expansion. At the same time, the supporting protuberances 70 on the second radial support members 66, which protuberances are configured as an integral part of the second mixing body part 34, can be shaped in the radial direction, such that different radial dimension changes can be compensated by deforming the second mixing body part 34 in the region of the supporting protuberances 70.

It should be noted that, as an alternative, the second support members 66 can also have the structure illustrated in FIGS. 6C and 6D. This means that, as an alternative, the second support members 66 can be provided by radially inward-pointing supporting protuberances that are provided on the mixing section housing 16 and are supported on the second mixing body part 34. The interaction between the radially mutually supported supporting protuberances on the mixing section housing 16, on the one hand, and on the second mixing body part 34, on the other hand, in the manner illustrated in FIG. 6D but without fixing such supporting protuberances on one another is also possible.

The support of the mixing body 18 in the mixing section housing 16 in its downstream end region 56 via the second mixing body part 18 makes it possible, in particular in this region of the mixing body 18, in which the reagent R injected into the first flow volume 24 also flows, to configure the first mixing body part 20, through which the reagent R or a mixture of reagent R and exhaust gas A flows on its inside, with a substantially smooth, unstructured surface. As a result, cavities in which deposits of the reagent R can form are avoided.

Finally, it should be noted that the configuration and the positioning of the first and second radial support members 58, 66 can be varied in many different aspects. Thus, for example, the second radial support members 66 or the second radial support region 52 can also or additionally be positioned further upstream, such that, for example, the mixing body 18 can be supported via the second radial support region 52 on the mixing section housing 16 in its longitudinal center region or additionally in its longitudinal center region. The various radial support members 58, 66 can also be provided in different numbers and can be offset with respect to one another in the circumferential direction. In the first radial support region 50, an annular support element could be positioned in the mixing section housing 16 between the first mixing body part 20 and the mixing section housing 16, for example, wherein this support element can have a multiplicity of openings that allow exhaust gas to pass through into the second flow volume 26. The web regions delimiting these openings in the circumferential direction then form radial support members in the sense according to the present disclosure.

It would also be possible in principle for the association of the first radial support region 50 and the second radial support region 52 with the two end regions 54, 56 of the mixing body 18 to be reversed. Thus, the mixing body 18 could be radially supported and fixed on the mixing section housing 16 in its downstream end region 56 via the first radial support members 58, which can then act between an axially projecting portion 72 of the first mixing body part 20 and the mixing section housing 16, while the second radial support members 66 acting between the second mixing body part 34 and the mixing section housing 16 can then be provided on the upstream end region 54 of the mixing body 18, for example.

Irrespective of the location of the positioning and the type of configuration of the various radial support members, these not only ensure a compensating function for different dimension changes and also for incorporating tolerance compensation but also serve for vibration damping in the radial direction and also, by virtue of the friction existing with respect to the other component in each case, in the axial direction and in the circumferential direction, especially if they are formed as protuberances. At the same time, these protuberances act as a centering aid during the installation of the mixing body 18 in the mixing section housing 16. Since the mixing body 18 is in contact with the mixing section housing 16 only via the various radial support members 58, 66 during the operation of a mixing section 12 of this kind, the outflow of heat to the outside via the mixing section housing 16 is simultaneously also minimized.

It is understood that the foregoing description is that of the preferred embodiments of the invention and that various changes and modifications may be made thereto without departing from the spirit and scope of the invention as defined in the appended claims.

1-19. (canceled)

20. A mixing section for an exhaust system of an internal combustion engine, the mixing section comprising:
a mixing section housing wherethrough exhaust gas can flow in a main exhaust-gas flow direction;
a tubular mixing body defining a mixing body longitudinal axis and being arranged in the mixing section housing and extending in the direction of said mixing body longitudinal axis;
said tubular mixing body radially outwardly delimiting a first flow volume through flowable by the exhaust gas;
said tubular mixing body radially inwardly delimiting a second flow volume through flowable by the exhaust gas;
said tubular mixing body including a tubular first mixing body part and at least one tubular second mixing body part;
said tubular first mixing body part extending in the direction of said mixing body longitudinal axis;
said at least one tubular second mixing body part extending in the direction of the mixing body longitudinal axis and being at an outer side of said tubular first mixing body part with said outer side toward said second flow volume;
said at least one tubular second mixing body part being supported radially on said tubular first mixing body part at a plurality of mixing-body-part support regions;
said tubular mixing body being supported radially with respect to said mixing section housing via a plurality of first radial support members in a first radial support region, and being supported radially with respect to the mixing section housing via a plurality of second radial support members in a second radial support region arranged at a distance from said first radial support region in the direction of said mixing body longitudinal axis;
said tubular first mixing body part being supported radially on said mixing section housing by said first radial support members; and,
said tubular second mixing body part being supported radially on said mixing section housing by said second radial support members.

21. The mixing section of claim 20, wherein said first mixing body part is held fast on said mixing section housing by said first radial support members at least against one of the following:
i) movement in the direction of the mixing body longitudinal axis; and,
ii) movement in the circumferential direction around the mixing body longitudinal axis; and,
wherein said second mixing body part is supported radially on said mixing section housing by said second radial support members in such a way that at least one of the following applies:
i) so as to be movable in the direction of the mixing body longitudinal axis; and,
ii) so as to be movable in the circumferential direction around the mixing body longitudinal axis.

22. The mixing section claim 20, wherein at least one of the following applies:
i) a plurality of said first radial support members is provided at a circumferential distance from one another in the circumferential direction around the mixing body longitudinal axis; and,
ii) a plurality of said second radial support members is provided at a circumferential distance from one another in the circumferential direction around the mixing body longitudinal axis.

23. The mixing section of claim 20, wherein at least some of said second radial support members comprise at least one of the following:
i) supporting protuberances on said second mixing body part pointing in a direction away from said first mixing body part; and,
ii) supporting protuberances on said mixing section housing pointing in a direction toward said second mixing body part.

24. The mixing section of claim 23, wherein said supporting protuberances on said second mixing body part are supported on an inner surface of said mixing section housing so as to be movable in at least one of the following ways:
i) in the direction of the mixing body longitudinal axis; and,
ii) in the circumferential direction around the mixing body longitudinal axis; and,
wherein the supporting protuberances on the mixing section housing are supported on an outer surface of said second mixing body part so as to be movable in at least one of the following ways:
i) in the direction of the mixing body longitudinal axis; and,
ii) in the circumferential direction around the mixing body longitudinal axis.

25. The mixing section of claim 20, wherein at least some of said first radial support members comprise support elements which are fixed on said mixing section housing and said first mixing body part.

26. The mixing section of claim 20, wherein at least some of said first radial support members comprise at least one of the following:
i) supporting protuberances on said first mixing body part which point in a direction toward the mixing section housing and are fixed on the mixing section housing; and,
ii) supporting protuberances on said mixing section housing which point in a direction toward said first mixing body part and are fixed on said first mixing body part.

27. The mixing section of claim 20, wherein at least one of the following applies:
i) said first radial support region is provided in an upstream end region of said mixing body with respect to the main exhaust-gas flow direction; and,
ii) said second radial support region is provided in a downstream end region of the mixing body.

28. The mixing section of claim 20, wherein at least some of said second radial support members overlap axially with some of said mixing-body-part support regions.

29. The mixing section of claim 20, wherein said second mixing body part has a plurality of first protuberances arranged adjacent to one another in the direction of the mixing body longitudinal axis and in the circumferential direction around the mixing body longitudinal axis and which point toward said first mixing body part and wherein at least one first protuberance forms a mixing-body-part support region.

30. The mixing section of claim 29, wherein at least one of the following applies:
i) said first protuberances are arranged in a plurality of rows of first protuberances which are arranged successively in the circumferential direction around the mixing body longitudinal axis; and,
ii) said first protuberances are arranged in a plurality of rings of first protuberances which are arranged successively in the direction of the mixing body longitudinal axis.

31. The mixing section claim 29, wherein at least one of the following applies:
i) at least some of the first protuberances are configured as a closed protuberance; and,
ii) at least some of the first protuberances are formed with a protuberance circumferential wall and a protuberance base, which rests against the first mixing body part and is planar or curved in a manner matched to a curvature of the first mixing body part; and,
iii) at least some of the first protuberances are of circular configuration.

32. The mixing section of claim 20, wherein said second mixing body part has a plurality of second protuberances arranged adjacent to one another in the direction of the mixing body longitudinal axis and in the circumferential direction around the mixing body longitudinal axis and pointing away from said first mixing body part.

33. The mixing section of claim 32, wherein at least one opening is provided in said second mixing body part adjoining at least some of the second protuberances, preferably wherein, in each pair consisting of mutually associated second protuberance and opening, the second protuberance and the opening overlap one another in some region or regions.

34. The mixing section of claim 32, wherein openings are provided in said second mixing body part adjoining adjusting corresponding ones of said second protuberance; wherein, in each pair comprised of mutually associated second protuberance and opening, said second protuberance and said opening overlap one another in some region or regions.

35. The mixing section of claim 33, wherein, in the case of some of the pairs comprised of mutually associated second protuberance and opening, the opening is arranged on a first side of the associated second protuberance and, in the case of others of the pairs comprised of mutually associated second protuberance and opening, the opening is arranged on a second side, substantially opposite the first side of the associated second protuberance.

36. The mixing section of claim 32, wherein at least one of the following applies:
i) said second protuberances are arranged in a plurality of rows of second protuberances which are arranged successively in the circumferential direction around the mixing body longitudinal axis and extend in the direction of the mixing body longitudinal axis; and,
ii) said second protuberances are arranged in a plurality of rings of second protuberances which are arranged successively in the direction of the mixing body longitudinal axis and extend in the circumferential direction around the mixing body longitudinal axis.

37. The mixing section of claim 20, wherein a reagent discharge arrangement for discharging reagent only into the first flow volume is arranged upstream of the mixing body in said main exhaust-gas flow direction.

38. The mixing section of claim 20, wherein said second mixing body part is fixed on the first mixing body part in the region of at least some of said mixing-body-part support regions of all the mixing-body-part support regions.

39. An exhaust system for an internal combustion engine, the exhaust system comprising:
a mixing section including:
a mixing section housing wherethrough exhaust gas can flow in a main exhaust-gas flow direction;
a tubular mixing body defining a mixing body longitudinal axis and being arranged in the mixing section housing and extending in the direction of said mixing body longitudinal axis;
said tubular mixing body radially outwardly delimiting a first flow volume through flowable by the exhaust gas;
said tubular mixing body radially inwardly delimiting a second flow volume through flowable by the exhaust gas;
said tubular mixing body including a tubular first mixing body part and at least one tubular second mixing body part;
said tubular first mixing body part extending in the direction of said mixing body longitudinal axis;
said at least one tubular second mixing body part extending in the direction of the mixing body longitudinal axis and being at an outer side of said tubular first mixing body part with said outer side toward said second flow volume;
said at least one tubular second mixing body part being supported radially on said tubular first mixing body part at a plurality of mixing-body-part support regions;
said tubular mixing body being supported radially with respect to said mixing section housing via a plurality of first radial support members in a first radial support region, and being supported radially with respect to the mixing section housing via a plurality of second radial support members in a second radial support region arranged at a distance from said first radial support region in the direction of said mixing body longitudinal axis;
said tubular first mixing body part being supported radially on said mixing section housing by said first radial support members;
said tubular second mixing body part being supported radially on said mixing section housing by said second radial support members; and,
an exhaust gas treatment unit arranged downstream of said mixing section.
